(19) United States
(12) Patent Application Publication
(10) Pub. No.: US 2004/0144415 A1
(43) Pub. Date: Jul. 29, 2004

(54) Ionomer/nylon films for use as backing layer for photovoltaic cells

(76) Inventor: Richard J. Arhart, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/728,326

(22) Filed: Dec. 3, 2003

Related U.S. Application Data
(60) Provisional application No. 60/430,498, filed on Dec. 3, 2002.

(51) Int. Cl. H02N 6/00

(52) U.S. Cl. 136/243

(57) ABSTRACT

The present invention is photovoltaic (solar) cell module comprising a sheet of ethylene acid copolymer ionomer/polyamide polymer blend, wherein the ionomer is dispersed in the continuous or co-continuous polyamide phase.

This application claims the benefit of U.S. Provisional Application No. 60/430,498, filed Dec. 3, 2002.

### BACKGROUND OF THE INVENTION

1. Field of the Invention

This invention relates to films useful as backing for photovoltaic (solar) cells. This invention particularly relates to films comprising blends of ethylene acid copolymer ionomers and nylon useful as backing for photovoltaic cells.

2. Description of the Related Art

Photovoltaic (solar) cells are units which are used to convert light energy into electrical energy which is in turn useful for powering machinery, electrical equipment and appliances. Typical construction of a solar cell module is a design which consists of 5 (five) layers. The layers in a conventional design have the following order in a solar cell, starting from the top, or incident layer (the layer first contacted by sunlight) and continuing to the backing (the layer furthest removed from the incident layer): incident layer/encapsulant layer/voltage-generating layer/second encapsulating layer/backing.

The purpose of the incident layer is to provide a transparent protective window that will allow for the entry of sunlight into the solar cell. The incident layer is typically a glass plate, but could conceivably be any material which is transparent to sunlight. The encapsulating layers are designed to encapsulate and protect the fragile voltage generating layer. The encapsulating layers are typically polymeric layers of ethylene/vinyl acetate copolymer (EVA), or layers of ethylene acid copolymer ionomers, however other materials can also be used. The individual encapsulating layers can be different or made from the same materials. The voltage-generating layer is typically a silicon wafer which converts the photons of sunlight into electrical energy.

The most important requirements for a solar cell backing are: (1) durability outdoors (that is, weatherability); (2) high dielectric strength (electricals); (3) low moisture vapor transmission rate (MVTR); and (4) mechanical strength. Any backing should have at least adequate performance in each of these important areas.

The backing in a solar cell can comprise various materials. The backing in conventional solar cells can be a multilayer laminate film. The laminate in many cases is a 3-layer laminate structure. The 3-layer structure is typically either: (1) Tedlar® (PVF)/polyester (PET)/EVA (4% vinyl acetate); or (2) Tedlar®/polyester/Tedlar®. While these systems have been used for years, they are not without problems, however. Tedlar is polyvinylfluoride. In either of the multilayer laminate backings, the backing is relatively expensive. Second, there is the possibility of delamination in the backing. Third, the step of laying the backing onto the EVA layer can be labor intensive, and subject to contamination and wrinkling.

A monolithic backing can be used, and has been described, in some solar cell module constructions as described in Proceedings of the 29^{th} IEEE Photovoltaics Specialists Conference, New Orleans, La., 2002, in a paper entitled “Backside Solutions” by S. R. Cosentino, S. B. Levy, and R. T. Tucker. The monolithic film can be a poly(ethylene glycol) terephthalate (PET) film which can be suitable as a backing for a solar cell or the monolithic backing can be glass. However, the use of the conventional backings are not trouble free.

It can be desirable, therefore, to eliminate the multilayer laminate construction in conventional backing in favor of a backing which reduces the problems encountered with laminate construction, while at the same time maintaining good performance in the four important performance areas for solar cell backings.

### SUMMARY OF THE INVENTION

In one aspect, the present invention is a multilayer photovoltaic (solar) cell module comprising a backing layer, wherein the backing is comprised or consists essentially of a blend of an ethylene/acid copolymer ionomer dispersed in a continuous or co-continuous polyamide phase.

In another aspect, the present invention is a process for preparing a backing for a solar cell wherein the backing is obtained from a blend of an ethylene acid copolymer ionomer dispersed in a continuous or co-continuous polyamide phase by a process comprising the step of making a blown film or an extrusion cast film from the blend.

### DETAILED DESCRIPTION OF THE INVENTION

In one embodiment, the present invention is a solar cell comprising a backing that comprises or consists essentially of a sheet of an ionomer/polyamide blend. Ionomers useful in the practice of the present invention are copolymers obtained by the copolymerization of ethylene and an ethylenically unsaturated C₃- C₈ carboxylic acid. Preferably the unsaturated carboxylic acid is either acrylic acid or methacrylic acid. The acid copolymer preferably includes from about 14 wt % to about 25 wt % of the acid. If the acid is methacrylic acid, the acid copolymer preferably includes from about 15 wt % to about 25 wt % methacrylic acid. In the final blends, the acid groups in the copolymer are highly neutralized to include from about 65 mole % to about 100 mole % of the neutralized acid carboxylate.

Polyamides suitable for use herein are preferably one or more semicrystalline polyamides such as polyepsiloncaprolactam (nylon 6) and polyhexamethylene adipamide (nylon-66). Amorphous polyamides can be substituted for a portion of the semicrystalline polyamide.

It has been found to be particularly preferable in obtaining the continuous or co-continuous polyamide phase, even when the ionomer is the major volume component, to melt-blend a partially neutralized ionomer (neutralized at a level of about 35 mole % to about 40 mole %) with the polyamide under intense mixing conditions, while concurrently neutralizing the ionomer to the desired level. Blends suitable for use in the present invention are described in, for example, U.S. Pat. No. 5,866,658, incorporated herein by reference.

The backing sheet of the present invention is a sheet of the ionomer/polyamide blend that has been extrusion cast into a sheet useful as a solar cell backing.

In still another embodiment the present invention is a sheet of the ionomer/polyamide blend that has been produced by a blown film process. Using a blown film process with the ionomer/polyamide blends useful in the practice of the present invention is not straightforward.

In the manufacturing process for solar cell modules, the various components of the module, such as, for example, the encapsulating layers, the voltage-generating layer, and including the backing sheet, are laid up in a vacuum lamination press and laminated together under vacuum with heat and pressure.

### EXAMPLES

The Examples and Comparative Examples are presented for illustrative purposes only, and are not intended to limit the scope of the present invention in any manner.

### Example 1

An ethylene acid copolymer ionomer/polyamide blend (Surlyn Reflections® SG201UC NC010, available from DuPont), was cast extruded in a single screw extruder through a coat hanger slit die at a melt temperature of approximately 255° C. with the addition of 4 wt % of white color concentrate (TiO₂) into a 0.01 inch thick sheet for use as a backing in solar cell modules. The backing was laminated to the exposed ionomer encapsulating layer of a solar module having the components, in order from the top (glass/ionomer/silicon voltage generating layer/ionomer). Adhesion of the backing to the ionomer was improved by corona treatment of the Surlyn® Reflections™ layer. The solar cell met the end use requirement standards, with acceptable performance in accelerated weathering tests.

### Example 2

A blown film was obtained from Surlyn Reflections® SG201UC NC010. The blown film can be laminated to an encapsulating layer for use as a backing in solar cell modules.

### Example 3

Moisture vapor transmission rate (MVTR) data measured on Surlyn Reflections(R) SG201UC extruded as sheet for use in the backing for solar PV modules is found in the following table. Comparison is made to commercial solar PV module backing materials like Tedlar(R)/polyester with either EVA or a second layer of Tedlar(R). MVTR was measured by ASTM method F1248.

TABLE 1
BACKING MATERIALS - MVTR

| Material | Thickness, mm | MVTR^{a} |
|---|---|---|
| SG201UC | 0.25 | 0.93 |
| Tedlar ®/PET/EVA^{c} | 0.19 | 0.19 (0.28)* |
| Tedlar ®/PET/Tedlar ®^{c} | 0.19 | 0.26 |
| Tedlar ®/PET/Tedlar ®^{c,}** | 0.17 | 0.32 |
| Surlyn ®^{c} | | 0.8-1.5^{b} |
| Nylon 6^{c} | | 20^{b} |

^{a}F1248 (37.8 deg C., 100% RH) grams/H2O/645 mm2 (100in2)/day
^{b}Reported values
^{c}Not an example of the present invention.
*Madico Company result by E-96 method in parenthesis
**Tested from opposite side of film

### Example 4

The dielectric or breakdown strength of Surlyn Reflections® SG201UC measured by ASTM method D149 in oil is found in Table 2. Comparison is made to Surlyn® and Nylon 6. Surlyn® Reflections exhibits high voltage breakdown resistance. Note that breakdown decreases with increasing sample thickness. These results indicate that Surlyn® Reflections has adequate dielectric voltage breakdown strength to perform as a backing layer for solar PV modules.

TABLE 2
DIELECTRIC STRENGTH (DS)

| | | DS Volt/mil |
|---|---|---|
| | Thickness, mil (mm) | (KVolt/mm) |
| SG201UC | 10.0 (0.254) | 1918 (75.5) |
| SG201UC | 24.0 (0.610) | 1052 (41.4) |
| Surlyn ®^{a} | 30 (0.762) | 800-1100 (31.5-43.3)^{b} |
| Surlyn ®^{a} | 130 (3.302) | 400-500 (15.7-19.7)^{b} |
| Nylon 6^{a} | 333 (8.458) | 300-400 (11.8-15.7)^{b} |

^{a}Not an example of the present invention.
^{b}Reported values.

What is claimed is:

1. A multilayer photovoltaic (solar) cell module comprising a backing layer, wherein the backing is comprised or consists essentially of a blend of an ethylene/acid copolymer ionomer dispersed in a continuous or co-continuous polyamide phase.

2. A process for preparing a backing for a solar cell wherein the backing is obtained from a blend of an ethylene acid copolymer ionomer dispersed in a continuous or co-continuous polyamide phase by a process comprising the step of making a blown film or an extrusion cast film from the blend.
